(19) United States
(12) Patent Application Publication
(10) Pub. No.: US 2024/0185618 A1
(43) Pub. Date: Jun. 6, 2024

(54) IMAGE GENERATION DEVICE, IMAGE GENERATION METHOD, AND PROGRAM

(71) Applicants: Toyota Jidosha Kabushiki Kaisha, Toyota-shi (JP); Denso Corporation, Kariya-city (JP)

(72) Inventor: Yuki YAMAMOTO, Toyota-shi (JP)

(73) Assignees: Toyota Jidosha Kabushiki Kaisha, Toyota-shi (JP); Denso Corporation, Kariya-city (JP)

(21) Appl. No.: 18/514,428

(22) Filed: Nov. 20, 2023

(30) Foreign Application Priority Data
Dec. 6, 2022 (JP) 2022-194767

(51) Int. Cl. G06V 20/56; G06V 20/58

(52) U.S. Cl. CPC G06V 20/588; G06V 20/58

(57) ABSTRACT

In generation of an underfloor image of a vehicle, a normal underfloor image is generated. Provided is a device for generating an underfloor image (220). The image generation device includes: an image generation module (130) configured to take in an image within a specific range (A1) from a captured image captured by a camera (40) enabled to capture at least a ground in a periphery of the vehicle (VH), and to generate the underfloor image (220) based on the taken-in image; an object detection module (140) configured to detect whether an object (OB) that integrally moves with the vehicle (VH) appears in the image within the specific range (A1); and an offset processing module (150) configured to execute offset processing of offsetting the specific range (A1) by a predetermined amount in the captured image when the object detection module (140) has detected the object (OB).

### CROSS-REFERENCE TO RELATED APPLICATION

This application claims priority to Japanese Patent Application No. JP2022-194767 filed on Dec. 6, 2022, the content of which is hereby incorporated by reference in its entirety into this application.

### BACKGROUND OF THE INVENTION

### 1. Field of the Invention

The present disclosure relates to an image generation device, an image generation method, and a program, and relates to a technology suitable for generation of an underfloor image indicating a ground below a vehicle.

### 2. Description of the Related Art

For example, in Japanese Patent Application Laid-open No. 2016-197785, there is disclosed a device which captures a ground in a moving direction of a vehicle through use of an in-vehicle camera, and displays the captured image as a current underfloor image of the vehicle after a predetermined time has elapsed.

An owner of a vehicle may retrofit an optional component (hereinafter referred to as “exterior component”) such as a step, a towing hitch, a bull bar, a kangaroo bar, and a spoiler to the vehicle. When such an exterior component appears in an image captured by the camera, because the exterior component moves integrally with the vehicle, the exterior component is always continuously displayed in the underfloor image. That is, there is a problem in that the underfloor image cannot normally be displayed.

### SUMMARY OF THE INVENTION

The present disclosure has been made in order to solve the above-mentioned problem, and has an object to normally generate an underfloor image.

A device according to at least one embodiment of the present disclosure is an image generation device for generating an underfloor image (220) indicating at least a ground below a vehicle (VH). The image generation device includes: an image generation module (130) configured to take in an image within a specific range (A1) from a captured image captured by a camera (40) enabled to capture at least a ground in a periphery of the vehicle (VH), and to generate the underfloor image (220) based on the taken-in image; an object detection module (140) configured to detect whether an object (OB) that integrally moves with the vehicle (VH) appears in the image within the specific range (A1); and an offset processing module (150) configured to execute offset processing of offsetting the specific range (A1) by a predetermined amount in the captured image when the object detection module (140) has detected the object (OB).

### BRIEF DESCRIPTION OF THE DRAWINGS

FIG. 1 is a schematic diagram for illustrating a hardware configuration of a vehicle in at least one embodiment of the present disclosure.

FIG. 2 is a schematic view for illustrating an arrangement and a capturing range of a camera sensor.

FIG. 3 is a schematic diagram for illustrating a software configuration of a control device in the at least one embodiment.

FIG. 4A is a schematic view for illustrating an example of an overhead image generated by an image generation module.

FIG. 4B is a schematic view for illustrating image data to be used to generate an underfloor image when the vehicle is traveling forward.

FIG. 4C is a schematic view for illustrating image data to be used to generate the underfloor image when the vehicle is traveling backward.

FIG. 5A, FIG. 5B, and FIG. 5C are schematic views for illustrating taking-in ranges of an image to be used to generate the underfloor image and offsetting of the taking-in range.

FIG. 6 is a flowchart for illustrating a routine of image generation processing.

### DESCRIPTION OF THE EMBODIMENTS

Description is now given of an image generation device, an image generation method, and a program according to at least one embodiment of the present disclosure with reference to the drawings.

### [Hardware Configuration]

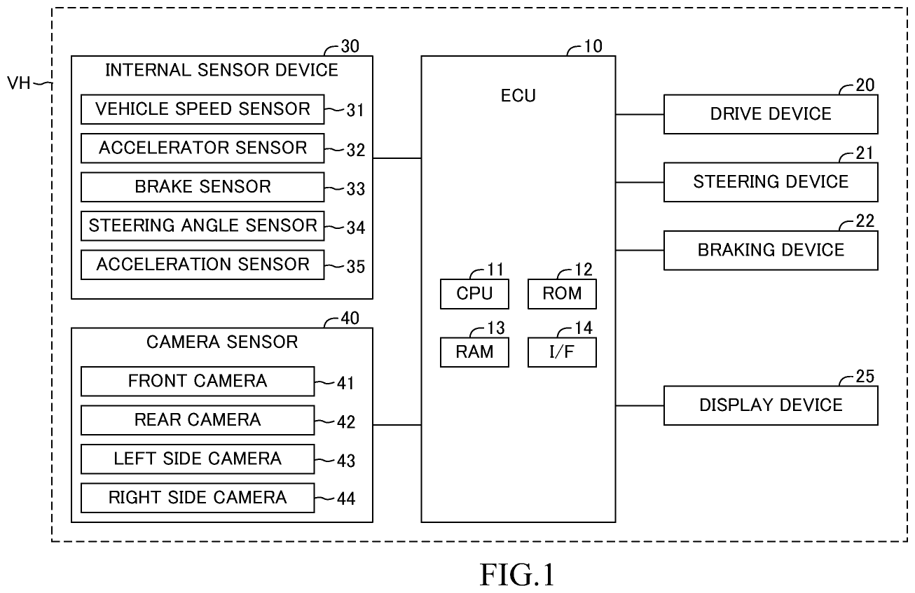

FIG. 1 is a schematic diagram for illustrating a hardware configuration of a vehicle VH in the at least one embodiment. The vehicle VH includes an electronic control unit (ECU) 10. The ECU 10 includes a central processing unit (CPU) 11, a read only memory (ROM) 12, a random access memory (RAM) 13, an interface device 14, and the like. The CPU 11 is a processor which executes various programs stored in the ROM 12. The ROM 12 is a nonvolatile memory, and stores data required for the CPU 11 to execute the various programs. The RAM 13 is a volatile memory, and provides a work area in which the various programs are loaded when the various programs are to be executed by the CPU 11. The interface device 14 is a communication device for communicating to and from an external device.

The ECU 10 is a central device which executes image generation processing and image display processing. To the ECU 10, a drive device 20, a steering device 21, a braking device 22, a display device 25, an internal sensor device 30, a camera sensor 40, and the like are connected for communication.

The drive device 20 generates a driving force to be transmitted to driving wheels of the vehicle VH. As the drive device 20, for example, an electric motor and an engine are given. In the device of the at least one embodiment, the vehicle VH may be any one of a hybrid electric vehicle (HEV), a plug-in hybrid electric vehicle (PHEV), a fuel cell electric vehicle (FCEV), a battery electric vehicle (BEV), and an engine vehicle. The steering device 21 applies a turning force to the wheels of the vehicle VH. The braking device 22 applies a braking force to the wheels of the vehicle VH.

The display device 25 is a display of a touch panel type (for example, a liquid crystal display of the touch panel type) provided to an instrument panel or the like of the vehicle VH. As the display device 25, for example, a display provided to a navigation device (not shown) may be used, but the display device 25 may be a display independent of the navigation device. The display device 25 displays various images in response to a command from the ECU 10.

The internal sensor device 30 is sensors which detect states of the vehicle VH. The internal sensor device 30 specifically includes a vehicle speed sensor 31, an accelerator sensor 32, a brake sensor 33, a steering angle sensor 34, an acceleration sensor 35, and the like. The vehicle speed sensor 31 detects a travel speed of the vehicle VH, that is, a vehicle speed of the vehicle VH. The accelerator sensor 32 detects an operation amount of an accelerator pedal (not shown) by a driver. The brake sensor 33 detects an operation amount of a brake pedal (not shown) by the driver. The steering angle sensor 34 detects a rotation angle, that is, a steering angle of a steering wheel or a steering shaft (not shown). The acceleration sensor 35 detects an acceleration of the vehicle VH. The internal sensor device 30 transmits, at a predetermined cycle, a state of the vehicle VH detected by each of the sensors 31 to 35 to the ECU 10.

The camera sensor 40 captures a periphery of the vehicle VH. The camera sensor 40 is, for example, a stereo camera or a monocular camera, and a digital camera including an image pickup element such as a CMOS device or a CCD can be used as the camera sensor 40. In the at least one embodiment, the camera sensor 40 includes a front camera 41, a rear camera 42, a left side camera 43, and a right side camera 44. The plurality of cameras 41 to 44 are also simply referred to as “camera sensor 40” when it is not required to distinguish those cameras 41 to 44 from one another.

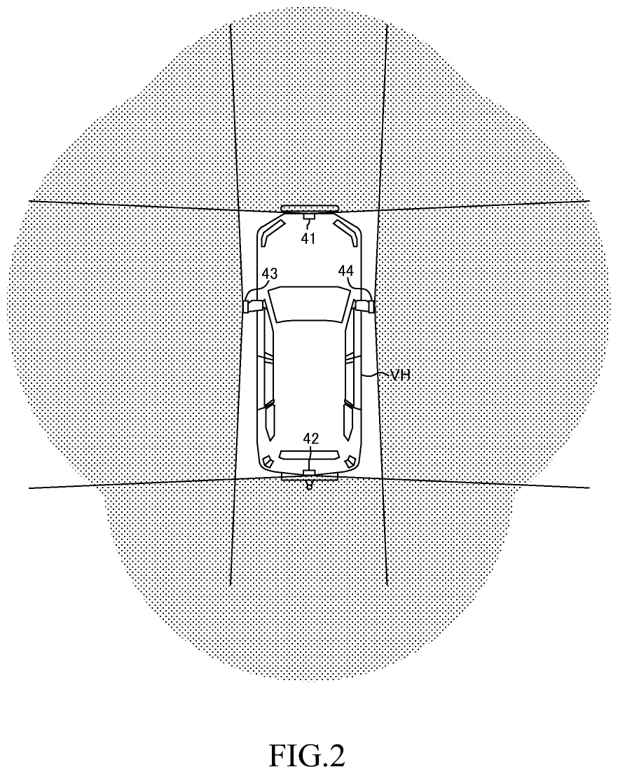

FIG. 2 is a schematic view for illustrating an arrangement and a capturing range of the camera sensor 40. The front camera 41 is provided in a substantially center portion (for example, a front grill) of a front portion of the vehicle VH in a vehicle width direction. An optical axis of the front camera 41 is directed forward and obliquely downward of the vehicle VH. The rear camera 42 is provided in a rear portion (for example, a back door) of the vehicle VH. An optical axis of the rear camera 42 is directed backward and obliquely downward of the vehicle VH. The left side camera 43 is provided in a left side portion (for example, a left side mirror) of the vehicle VH. An optical axis of the left side camera 43 is directed leftward and obliquely downward of the vehicle VH. The right side camera 44 is provided in a right side portion (for example, a right side mirror) of the vehicle VH. An optical axis of the right side camera 44 is directed rightward and obliquely downward of the vehicle VH.

The camera sensor 40 includes a wide angle lens, and captures a right range, a left range, a lower range, and an upper range with respect to the optical axis as a reference. That is, the camera sensor 40 can acquire image data in an entire periphery of the vehicle VH including a ground and a region above the ground in the periphery of the vehicle VH. The camera sensor 40 transmits the acquired image data to the ECU 10 at a predetermined cycle.

### [Software Configuration]

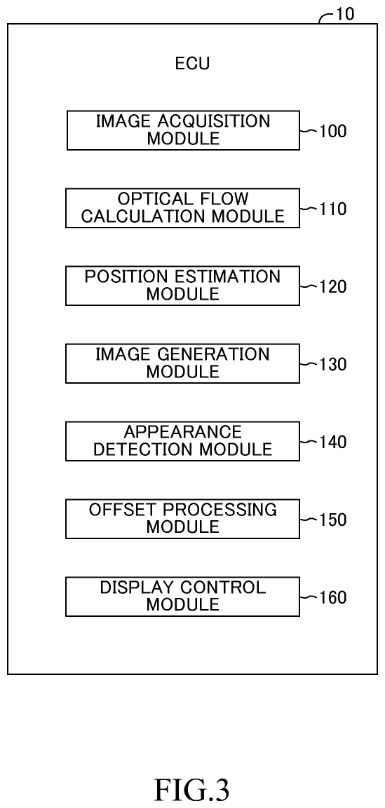

FIG. 3 is a schematic diagram for illustrating a software configuration of the ECU 10 in the at least one embodiment. As illustrated in FIG. 3, the ECU 10 includes, as functional elements, an image acquisition module 100, an optical flow calculation module 110, a position estimation module 120, an image generation module 130, an appearance detection module 140, an offset processing module 150, and a display control module 160. Each of those functional elements 100 to 160 is implemented by the CPU 11 of the ECU 10 reading out a program stored in the ROM 12 into the RAM 13 and executing the read-out program. A part of or all of the functional elements 100 to 160 may be provided in another ECU independent of the ECU 10 or in an information processing device of a facility (a management center or the like) communicable to and from the vehicle VH.

The image acquisition module 100 acquires the image data captured by the camera sensor 40, and stores the acquired image data in a storage device such as the RAM 13. Specifically, each time the vehicle VH moves a predetermined distance, the image acquisition module 100 stores the image data captured by the camera sensor 40 at this time point in association with position information on the vehicle VH estimated by the position estimation module 120 described later, a state amount of the vehicle VH acquired by the internal sensor device 30, and the like. The image acquisition module 100 stores, in the storage device, the image data on a portion in front of the vehicle VH captured by the front camera 41 when the vehicle VH travels, for example, forward. Moreover, the image acquisition module 100 stores, in the storage device, the image data on a portion behind the vehicle VH captured by the rear camera 42 when the vehicle VH travels, for example, backward.

The optical flow calculation module 110 calculates an optical flow based on the image data captured by the camera sensor 40. The optical flow is one of methods for moving object analysis, and is information indicating a motion of an object appearing in image data as a vector. The optical flow calculation module 110 compares current image data acquired by the image acquisition module 100 and past image data stored by the image acquisition module 100 before the vehicle VH travels the predetermined distance, and calculates the optical flow from transition vectors of objects having matching feature points.

In the at least one embodiment, the optical flow calculation module 110 does not use an entire range of the image data to calculate the optical flow, but uses image data within a predetermined taking-in range (first range A1, second range A2, . . . , n-th range An) described later to calculate the optical flow. It is possible to reduce a processing load on the CPU 11 and a calculation time by limiting the image data used for the calculation of the optical flow to the image data within the predetermined taking-in range in this manner.

The position estimation module 120 estimates a current position (position information) of the vehicle VH based on a movement amount of the vehicle VH. Specifically, the position estimation module 120 calculates the movement amount of the vehicle VH based on the optical flow calculated by the optical flow calculation module 110, to thereby estimate the current position of the vehicle VH. When a road surface on which the vehicle VH is traveling is in a road surface state, such as that of a paved road, in which wheelspin is less likely to occur in the driving wheels, the position estimation module 120 may calculate the movement amount of the vehicle VH through odometry based on detection results of the vehicle speed sensor 31 and the steering angle sensor 34.

The image generation module 130 generates an overhead image obtained by viewing the vehicle VH vertically above based on the image data captured by the camera sensor 40. A method of generating the overhead image is not particularly limited, and a publicly known method such as a method that uses a mapping table may be used. The image generation module 130 generates the overhead image each time the image acquisition module 100 acquires the image data from the camera sensor 40.

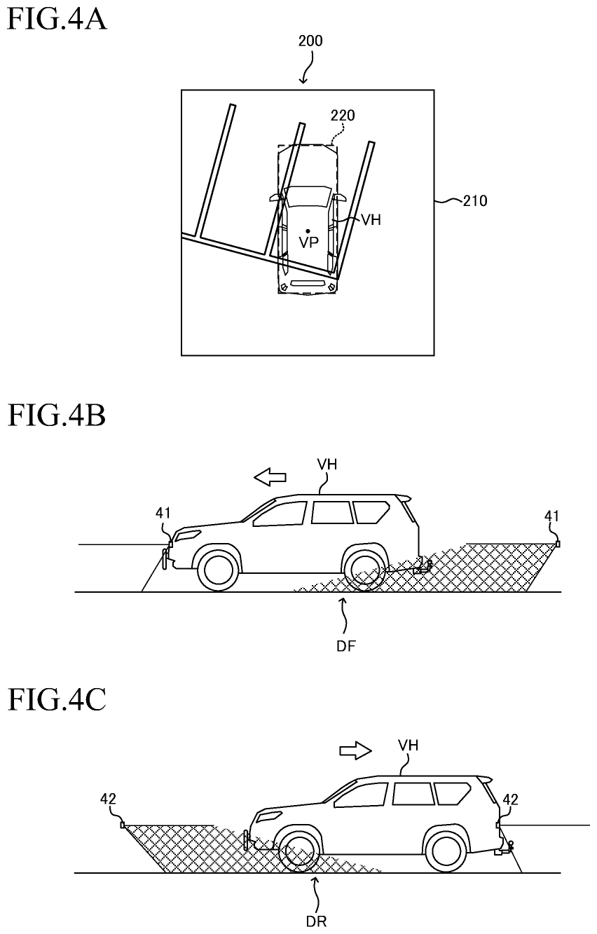

FIG. 4A is a schematic view for illustrating an example of an overhead image 200 generated by the image generation module 130. The image generation module 130 generates a peripheral image 210 and an underfloor image 220 as the overhead image 200. Here, the peripheral image 210 is an image indicating a peripheral (front, rear, left, and right) region other than the vehicle VH when the vehicle VH is viewed vertically above from a virtual viewpoint VP. Moreover, the underfloor image 220 is an image indicating the ground under a floor as viewed transparently through the vehicle VH when the vehicle VH is viewed vertically above from the virtual viewpoint VP.

The virtual viewpoint VP is not limited to the point in the direction vertically above the vehicle VH, and the virtual viewpoint VP can be set to, for example, a position backward and obliquely upward of the vehicle VH or can be set inside a vehicle cabin of the vehicle VH in response to a request from an occupant of the vehicle VH. When the virtual viewpoint VP is set to the position backward and obliquely upward of the vehicle VH, it is possible to effectively present, to the occupant of the vehicle VH, a side clearance to a peripheral object and the like. Moreover, when the virtual viewpoint VP is set inside the vehicle cabin of the vehicle VH and an underfloor image in a vicinity of a tire is generated as viewed through a floor portion of the vehicle VH, it is possible to effectively present a road surface situation in the vicinity of the tire at a time of offroad travel or the like.

The image generation module 130 generates the peripheral image 210 based on the image data (that is, the newest image data captured by each of the front camera 41, the rear camera 42, the left side camera 43, and the right side camera 44) at the current time point. Meanwhile, the underfloor image 220 at the current time cannot be generated from the newest image data. The image generation module 130 uses the image data captured by the camera sensor 40 (the front camera 41 and the rear camera 42) at a position apart from the current position of the vehicle VH by a predetermined distance in a direction opposite to the traveling direction to generate the underfloor image 220.

As illustrated in FIG. 4B, the image generation module 130 uses image data DF captured by the front camera 41 at the position apart from the current position by the predetermined distance behind the vehicle VH to generate the underfloor image when the vehicle VH is traveling forward. Meanwhile, as illustrated in FIG. 4C, the image generation module 130 uses image data DR captured by the rear camera 42 at the position apart from the current position by the predetermined distance in front of the vehicle VH to generate the underfloor image when the vehicle VH is traveling backward. As the image data to be used to generate the underfloor image, it is only required to use the image data stored by the image acquisition module 100 in the storage device in association with the position information of the vehicle VH and the like. The predetermined distance is not particularly limited, and it is only required to set the predetermined distance based on specific specifications of the vehicle VH and the camera sensor 40 (the front camera 41 and the rear camera 42) and the like. It is only required to obtain whether the vehicle VH has moved forward or backward by the predetermined distance based on an estimation result obtained by the position estimation module 120.

In this case, when the entire range of the image data is taken in to generate the underfloor image at the time of the generation of the underfloor image by the image generation module 130, the processing load on the CPU 11 and a time required to generate the image increase. Moreover, when the image generation module 130 uses an image in a far range apart from the vehicle VH in the image data to generate the underfloor image, an image in which angles of peripheral structures and the like are unnatural and which has a low resolution is generated. In particular, when the virtual viewpoint VP is set to the position backward and obliquely upward of the vehicle VH, the angles of the peripheral structures and the like are unnatural, and hence the driver of the vehicle VH feels strange.

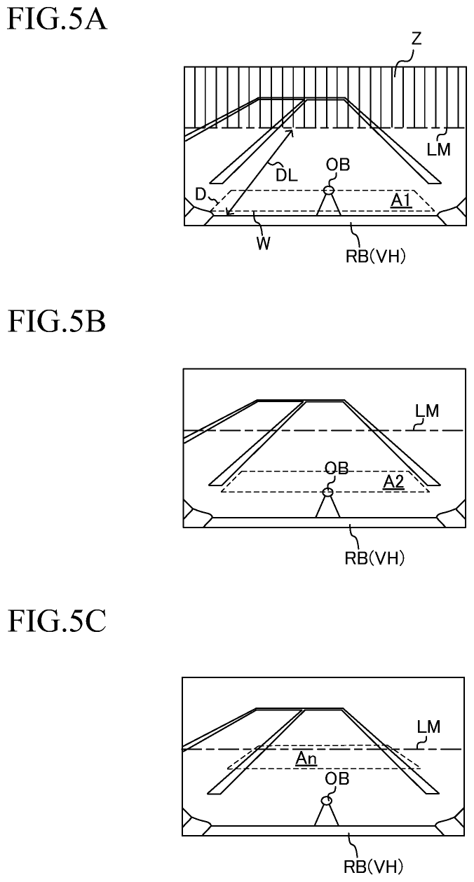

Thus, the image generation module 130 takes in image data within a predetermined taking-in range (specific range) set in advance of an entire range of the image data, to thereby generate the underfloor image. FIG. 5A is a schematic view for illustrating a first range A1 set as a default taking-in range. Processing of taking in the image and processing of generating the underfloor image have substantially the same contents for both of the front camera 41 and the rear camera 42, and hence only the case of the rear camera 42 is now described.

In FIG. 5A, reference symbol RB denotes a rear bumper of the vehicle VH, and reference symbol LM denotes an upper limit line for taking in the image. Here, the upper limit line LM is a line serving as such a reference that when image data in a range Z apart from the vehicle VH farther than the upper limit line LM is used, the underfloor image cannot be generated at a desired resolution, and angles of peripheral structures and the like are also unnatural. That is, the range Z apart from the vehicle VH farther than the upper limit line LM in the image data is considered as a range inappropriate for the generation of the underfloor image. The range Z is an example of a predetermined range in the present disclosure. A specific numerical value of the upper limit line LM is not particularly limited, and is only required to be set based on a capability of the rear camera 42 and the like. The upper limit line LM may be a fixed value, or may be a variable value in accordance with a vehicle speed and a posture of the vehicle VH, a peripheral environment (day or night and rainy weather or fine weather), and the like at the time when the rear camera 42 captures the image data. A front-rear direction of the vehicle VH in the image data is hereinafter referred to as “longitudinal direction,” and a vehicle width direction orthogonal to the front-rear direction of the vehicle VH is hereinafter referred to as “lateral direction.”

As illustrated in FIG. 5A, the first range A1 is set immediately below a rear end of the vehicle VH. Specifically, a lateral length W of the first range A1 is set to a length substantially the same as the vehicle width of the vehicle VH. Moreover, a longitudinal length D of the first range A1 is set to a predetermined length from a position immediately below a rear end of the rear bumper RB in the longitudinal direction. The longitudinal length D is not particularly limited, and when a distance from the rear end of the rear bumper RB to the upper limit line LM is represented by a distance DL, the longitudinal length D is set to a length (D<DL/2) shorter than half of the distance DL. That is, the longitudinal length D is set such that even when the taking-in range is offset by the longitudinal length D from the first range A1 through offset processing described later, a second range A2 after the offset does not exceed the upper limit line LM. In other words, there is provided such a configuration that the offset processing described later can be executed at least one time before the taking-in range reaches the upper limit line LM.

Incidentally, an exterior component such as a step, a towing hitch, a bull bar, or a kangaroo bar may be retrofit to the vehicle VH in accordance with preference of the owner, a purpose of use of the vehicle, and the like. When such an exterior component appears in the image data of the rear camera 42, the exterior component is always continuously displayed in the underfloor image 220, and hence there is a problem in that the underfloor image 220 cannot normally be displayed.

The appearance detection module 140 detects whether or not an object (hereinafter referred to as “integrally moving object OB”) such as the exterior component moving integrally with the vehicle VH appears in the taking-in range of the image data captured by the rear camera 42. In the at least one embodiment, the appearance detection module 140 detects whether or not the integrally moving object OB appears in the taking-in range of the image data based on the optical flow calculated by the above-mentioned optical flow calculation module 110 using the image within the taking-in range. Specifically, when the appearance detection module 140 acquires an object substantially matching a transition vector of the vehicle VH in the image based on the calculation result of the optical flow, the appearance detection module 140 detects this object as an integrally moving object OB appearing in the image. When the appearance detection module 140 detects an integrally moving object OB, the appearance detection module 140 transmits a result of this detection to the offset processing module 150.

The method of detecting the integrally moving object OB is not limited to the method that uses the optical flow, and the integrally moving object OB may be detected through machine learning such as the pattern matching.

When the appearance detection module 140 detects an integrally moving object OB, the offset processing module 150 executes the offset processing of moving, in the longitudinal direction, the taking-in range for the image to be used to generate the underfloor image. As illustrated in FIG. 5A, when the appearance detection module 140 detects an integrally moving object OB (a towing hitch in the illustrated example) within the first range A1, the offset processing module 150 offsets the taking-in range to the second range A2 which is moved from the first range A1 by the longitudinal length D in the longitudinal direction as illustrated in FIG. 5B.

The offset processing module 150 sets the second range A2 as the taking-in range for the underfloor image generation when the appearance detection module 140 does not detect the integrally moving object OB in the second range A2 after the taking-in range is offset to the second range A2. Meanwhile, the offset processing module 150 further offsets the taking-in range from the second range A2 by the longitudinal length D in the longitudinal direction when the appearance detection module 140 detects the integrally moving object OB in the second range A2 after the taking-in range is offset to the second range A2 as illustrated in FIG. 5B. That is, the offsetting of the taking-in range in the longitudinal direction is repeatedly executed until the integrally moving object OB is not detected by the appearance detection module 140. As a result, the image generation module 130 can generate the underfloor image based on the image in which the integrally moving object OB such as an exterior component or the like is not appearing. That is, a normal underfloor image can be generated.

As illustrated in FIG. 5C, when an n-th range An (“n” is an integer equal to or larger than 3) which is the taking-in range reaches the upper limit line LM, in more detail, when the upper limit line LM is included in the n-th range An before the appearance detection module 140 no more detects the integrally moving object OB from the image within the taking-in range, the offset processing module 150 transmits an inhibition command for inhibiting the generation of the underfloor image to the image generation module 130. As a result, it is possible to prevent the generation of an underfloor image which has a low resolution and unnatural angles of peripheral structures.

When the display control module 160 receives a request from an occupant of the vehicle VH, the display control module 160 displays the overhead image 200 (the peripheral image 210 and/or the underfloor image 220) generated by the image generation module 130 on the display device 25. Moreover, when the offset processing module 150 has transmitted the inhibition command to the image generation module 130 at the time of the reception of the request from the occupant of the vehicle VH, the display control module 160 displays, on the display device 25, a message notifying the occupant that the generation or the display of the underfloor image is impossible. The message is not limited to the display by the display device 25, and the message may be displayed by simultaneously using sound of a speaker.

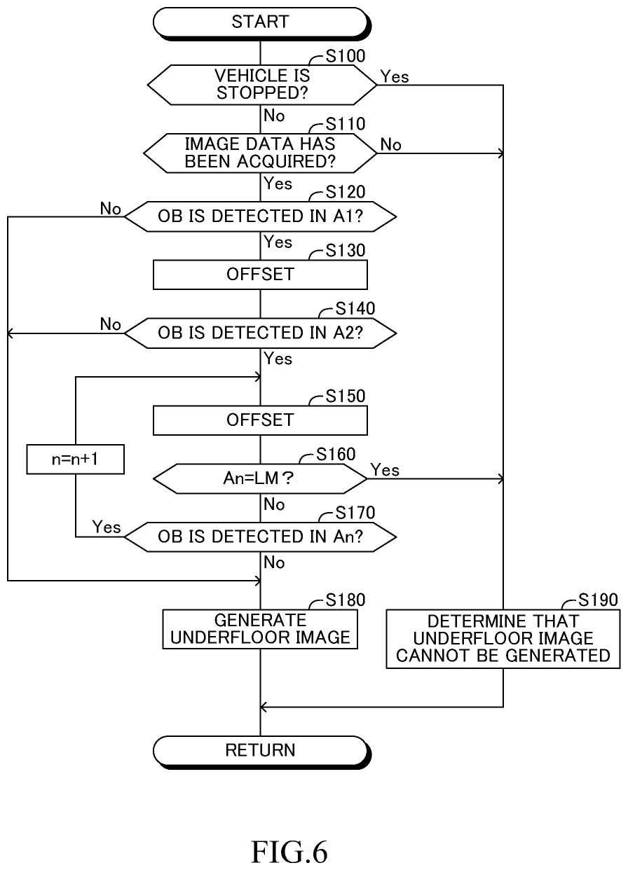

With reference to a flowchart of FIG. 6, description is now given of a routine of the image generation processing executed by the CPU 11 of the ECU 10. It is assumed in the following that the offset amount (longitudinal length D) of the taking-in range is set to a length shorter than half of the distance DL from the rear end of the vehicle VH to the upper limit line LM in the image data. That is, the offset processing can be executed at least one time.

In Step S100, the ECU 10 determines whether or not the vehicle VH is stopped. It is only required to determine whether or not the vehicle VH is stopped based on, for example, the detection result obtained by the vehicle speed sensor 31. When the vehicle VH is stopped (Yes), the ECU 10 advances the process to Step S190, determines that the generation of the underfloor image is impossible, and returns from this routine. Meanwhile, when the vehicle VH is not stopped (No), that is, the vehicle VH is traveling, the ECU 10 advances the process to Step S110.

In Step S110, the ECU 10 determines whether or not the image data captured by the rear camera 42 at the position apart by a predetermined distance from the current position of the vehicle VH behind the vehicle VH has been acquired. When the image data has been acquired (Yes), the ECU 10 advances the process to Step S120. Meanwhile, when the image data has not been acquired (No), the ECU 10 advances the process to Step S190, determines that the generation of the underfloor image is impossible, and returns from this routine.

In Step S120, the ECU 10 determines whether or not an integrally moving object OB is detected in the first range A1 of the image data based on the optical flow. When an integrally moving object OB is not detected in the first range A1 (No), the ECU 10 advances the process to Step S180, and generates the underfloor image based on the image in the current taking-in range (that is, the first range A1). Meanwhile, when an integrally moving object OB is detected in the first range A1 (Yes), the ECU 10 advances the process to Step S130.

In Step S130, the ECU 10 sets the taking-in range to the second range A2 offset from the first range A1 by the longitudinal length D in the longitudinal direction. After that, in Step S140, the ECU 10 determines whether or not an integrally moving object OB is detected in the second range A2 of the image data based on the optical flow. When an integrally moving object OB is not detected in the second range A2 (No), the ECU 10 advances the process to Step S180, and generates the underfloor image based on the image in the current taking-in range (that is, the second range A2). Meanwhile, when an integrally moving object OB is detected in the second range A2 (Yes), the ECU 10 advances the process to Step S150.

In Step S150, the ECU 10 sets the taking-in range to the n-th range An (“n” is an integer equal to or larger than 3) obtained by offsetting the taking-in range by the longitudinal length D in the longitudinal direction. After that, in Step S160, the ECU 10 determines whether or not the n-th range An has reached the upper limit line LM. When the n-th range An has reached the upper limit line LM (Yes), the ECU 10 advances the process to Step S190, determines that the generation of the underfloor image is impossible, and returns from this routine. Meanwhile, when the n-th range An has not reached the upper limit line LM (No), the ECU 10 advances the process to Step S170.

In Step S170, the ECU 10 determines whether or not an integrally moving object OB is detected in the n-th range An of the image data based on the optical flow. When an integrally moving object OB is not detected in the n-th range An (No), the ECU 10 advances the process to Step S180, and generates the underfloor image. Meanwhile, when an integrally moving object OB is detected in the n-th range An (Yes), the ECU 10 counts up “n” (n=n+1) in Step S175, and returns the process to Step S150. That is, before the taking-in range reaches the upper limit line LM, the offsetting of the taking-in range is repeated until the integrally moving object OB is no more detected.

According to the at least one embodiment described in detail above, when the appearance detection module 140 detects the appearance of the integrally moving object OB in the image within the taking-in range, the offset processing module 150 executes the offset processing of moving the taking-in range in the longitudinal direction. The offset processing module 150 repeatedly executes the offsetting of the taking-in range until the integrally moving object OB is no more detected by the appearance detection module 140. As a result, the image generation module 130 can generate the underfloor image based on the image in which the integrally moving object OB does not appear. That is, a normal underfloor image in which the exterior component or the like does not appear can be displayed on the display device 25.

The present disclosure is not limited to the above-mentioned at least one embodiment, and various changes are possible within the range not departing from the object of the present disclosure.

For example, in the above-mentioned at least one embodiment, description is given while assuming that the offsetting of the taking-in range is executed by the offset processing module 150 when the appearance detection module 140 detects an integrally moving object OB, but the taking-in range may be allowed to be offset to any range through an operation (for example, a touch operation on the display device 25 or the like) of the occupant of the vehicle VH. Moreover, in the above-mentioned at least one embodiment, description is given while assuming that the offset amount of the taking-in range is set to the longitudinal length D, but an offset amount may be shorter than the longitudinal length D, that is, the taking-in ranges before and after the offsetting may partially overlap with each other. Moreover, the application of the present disclosure is not limited to the generation of the underfloor image of the vehicle VH, and the present disclosure can widely be applied to generation of other images in which the appearance of the object integrally moving with the vehicle VH is undesirable.

What is claimed is:

1. An image generation device for generating an underfloor image indicating at least a ground below a vehicle, the image generation device comprising:
an image generation module configured to take in an image within a specific range from a captured image captured by a camera enabled to capture at least a ground in a periphery of the vehicle, and to generate the underfloor image based on the taken-in image;
an object detection module configured to detect whether an object that integrally moves with the vehicle appears in the image within the specific range; and
an offset processing module configured to execute offset processing of offsetting the specific range by a predetermined amount in the captured image when the object detection module has detected the object.

2. The image generation device according to claim 1, wherein the offset processing module is configured to repeat, when the offset processing has been executed and the object detection module detects the object in the image within the specific range that has been offset, the offset processing until the object detection module no more detects the object.

3. The image generation device according to claim 2,
wherein the offset processing module is configured to set a predetermined range apart from the vehicle in the captured image as a range inappropriate for the generation of the underfloor image, and to offset the specific range toward a direction away from the vehicle when the offset processing module executes the offset processing, and
wherein the image generation module is configured to avoid the generation of the underfloor image in a case in which at least a part of the specific range that has been offset reaches the predetermined range when the offset processing module executes the offset processing as a result of the detection of the object by the object detection module.

4. An image generation method of generating an underfloor image indicating at least a ground below a vehicle, the image generation method comprising:
taking in an image within a specific range from a captured image captured by a camera enabled to capture at least a ground in a periphery of the vehicle, and generating the underfloor image based on the taken-in image;
detecting whether an object that integrally moves with the vehicle appears in the image within the specific range; and
offsetting the specific range by a predetermined amount in the captured image when the object has been detected in the detecting.

5. A program for causing a computer of an image generation device for generating an underfloor image indicating at least a ground below a vehicle to execute:
taking in an image within a specific range from a captured image captured by a camera enabled to capture at least a ground in a periphery of the vehicle, and generating the underfloor image based on the taken-in image;
detecting whether an object that integrally moves with the vehicle appears in the image within the specific range; and
offsetting the specific range by a predetermined amount in the captured image when the object has been detected in the detecting.
